(19) United States
(12) Patent Application Publication
(10) Pub. No.: US 2009/0050063 A1
(43) Pub. Date: Feb. 26, 2009

(54) FEEDING DEVICE USING AIR FLOW

(76) Inventors: SHIH-MING CHANG, Zhanggi Industrial Zone (CN); Jin Jun Cao, Ningbo (CN)

Correspondence Address: LEONG C LEI, PMB # 1008, 1867 YGNACIO VALLEY ROAD, WALNUT CREEK, CA, 94598, US

(21) Appl. No.: 11/843,666

(22) Filed: Aug. 23, 2007

(51) Int. Cl. A01K 5/00; A01K 39/01

(52) U.S. Cl. 119/51.01

(57) ABSTRACT

The feeding device contains a barrel, a discharge pipe, a feed pipe, and a blower. The grainy feedstuff is fed to the blower and then is blown upward into the barrel via the feed pipe. Extraneous air is expelled from the barrel via the discharge pipe. The feeding device efficiently simplifies and speeds up the process of loading feedstuff into the barrel.

### TECHNICAL FIELD OF THE INVENTION

The present invention generally relates to feeding devices for feedstuff, and more particularly to a feeding device using air flow to deliver grainy feedstuff.

### DESCRIPTION OF THE PRIOR ART

Feedstuff is commonly made into grains or powders for the digestion of the stock or poultry. The grainy feedstuff is usually stored in a barrel raised above the ground for about 2 to 3 meters for automatic distribution and to prevent the barrel from being damage by the stock or poultry.

Therefore, a worker has to carry the feedstuff and climb a ladder in order to fill up the barrel. This is a laborious task and, in the process, grains or powders may float and pollute the air, thereby damaging the health of the worker. Even though there are already some feeding devices for filling up the barrel, the worker again has to climb up to the barrel and connect the feeding device to the barrel, still a hazardous task.

### SUMMARY OF THE INVENTION

The primary purpose of the present invention is to provide a feeding device, which contains a barrel, a discharge pipe, a feed pipe, and a blower. The barrel is raised above the ground for a distance for the storage of grainy feedstuff. The discharge pipe has one end connected to the barrel. The two ends of the feed pipe are connected to the barrel and the blower, respectively. The blower generates air flow to deliver the feedstuff into the barrel via the feed pipe. The extraneous air inside the barrel is expelled from the barrel via the discharge pipe. The feeding device, as such, efficiently simplifies and speeds up the process of loading feedstuff into the barrel.

The discharge pipe contains a hinged door that is shut automatically when the loading process is over. In this way, the feedstuff stored in the barrel is protected from bugs or insects or dirt.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing a feeding device according to an embodiment of the present invention.

FIG. 2 is a perspective view showing the connection of the discharge and feed pipes to the barrel of FIG. 1.

FIG. 3 is an enlarged view of FIG. 2.

FIG. 4 is a sectional view showing the feeding device of FIG. 1.

FIG. 5 shows the operation scenario of the feeding device of FIG. 1.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

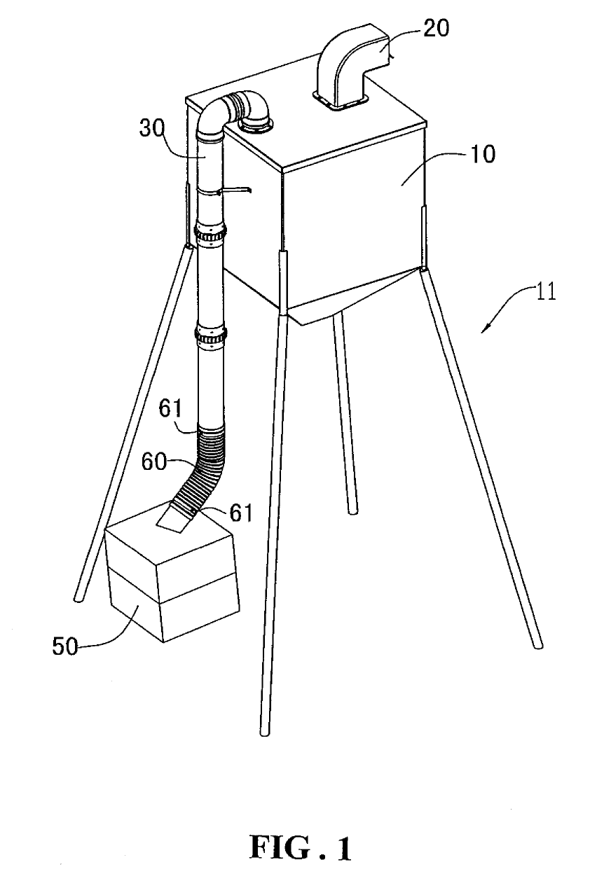

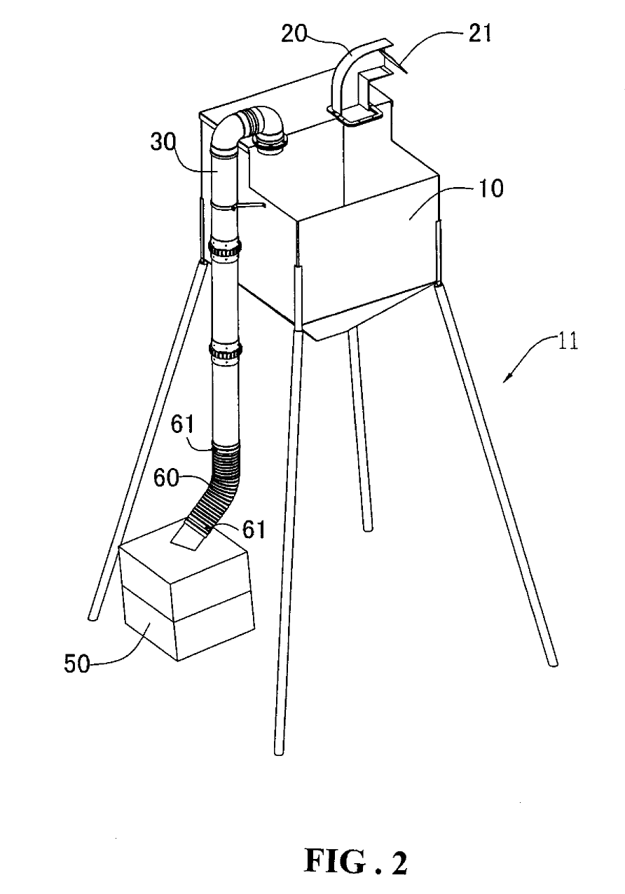

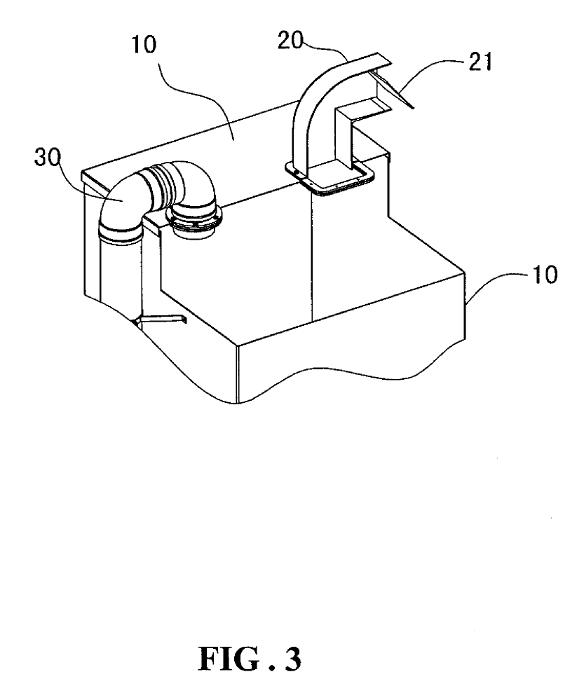

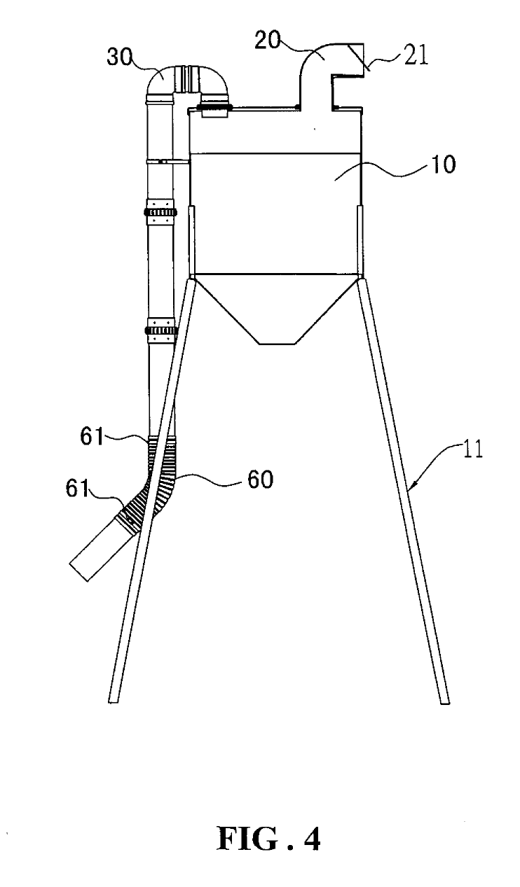

As shown in FIGS. 1 to 4, a feeding device according to an embodiment of the present invention contains a barrel 10, a discharge pipe 20, a feed pipe 30, a connection pipe 60, and a blower 50. As illustrated, the barrel 10 is raised above the ground by a number of legs 11 for a distance for the storage of the feedstuff.

Both the discharge pipe 20 and the feed pipe 30 have a first end connected to a top side of the barrel 10, respectively. A second end of the feed pipe 30 is then connected to an outlet (not numbered) of the blower 50 via the connection pipe 60. The connection pipe 60 is made of a flexible material such as rubber. There are fastening rings 61 fixedly joining the two ends of the connection pipe 60 to the second end of the feed pipe 30 and the outlet of the blower 50, respectively.

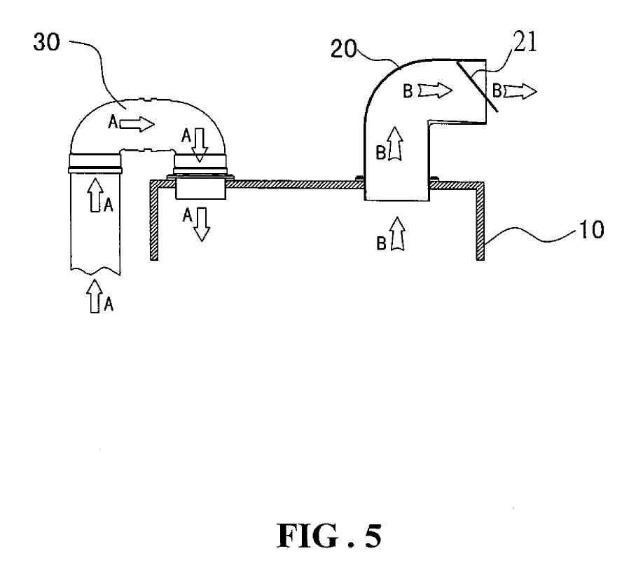

FIG. 5 illustrates the operation scenario of the feeding device of the present embodiment. As illustrated, the grainy feedstuff is fed to the blower 50 and then is blown upward into the barrel 10 via the connection pipe 60 and the feed pipe 30, as indicated by the arrow A. The flexibility of the connection pipe 60 absorbs the extraneous pressure and vibration produced by the blower 50 so as to provide reliable connection between the feed pipe 30 and the blower 50. As the air carries the feedstuff into the barrel 10, extraneous air is expelled from the barrel 10 via the discharge pipe 20, as indicated by the arrow B.

As illustrated in the drawings, an outward-only hinged door 21 is provided adjacent to a second end of the discharge pipe 20. When the feedstuff is blown into the barrel 10, the extraneous air would push the door 21 open. When the loading process is over and the blower 50 is turned off, the door 21 automatically shuts the discharge pipe 20, therefore completely sealing the feedstuff in the airtight barrel 10 and preventing bugs and dirt from entering the barrel 10. Further more, a control device (not shown) can be provided to manually or electrically adjust how much the door 21 is opened (i.e., the opening of the second end of the discharge pipe 20). In this way, the speed of blowing feedstuff into the barrel 10 can be fine-tuned.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1-5. (canceled)

6. A feeding device for grainy feedstuff, comprising:
a barrel raised above ground and having a top side;
a feed pipe having a first end and a second end, said first end of said feed pipe extending upwardly into said barrel through said top side;
a discharge pipe having a first end and a second end, said second end of said discharge pipe extending upwardly into said barrel through said top side; said first end of said discharge pipe being a horizontal outlet, said horizontal outlet having an inner top side provided with a hinged door which is open outward only; and
a connection pipe made of flexible material whose two ends are fixedly connected to said second end of said feed pipe and said blower respectively.
